(19) United States
(12) Patent Application Publication
(10) Pub. No.: US 2017/0140474 A1
(43) Pub. Date: May 18, 2017

(54) SYSTEM AND METHOD FOR A MICRO-TRANSACTION BASED, CROWD-SOURCED EXPERT SYSTEM THAT PROVIDES ECONOMIC INCENTIVIZED REAL-TIME HUMAN EXPERT ANSWERS TO QUESTIONS, AUTOMATED QUESTION CATEGORIZATION, PARSING, AND PARALLEL ROUTING OF QUESTIONS TO EXPERTS, GUARANTEED RESPONSE TIME AND EXPERT ANSWERS

(71) Applicants: Hung Tran, Palo Alto, CA (US); Peter Relan, Atherton, CA (US); Tanuj Bathla, San Francisco, CA (US); Thomas Hornbeck, Iowa City, IA (US)

(72) Inventors: Hung Tran, Palo Alto, CA (US); Peter Relan, Atherton, CA (US); Tanuj Bathla, San Francisco, CA (US); Thomas Hornbeck, Iowa City, IA (US)

(21) Appl. No.: 14/938,859

(22) Filed: Nov. 12, 2015

(51) Int. Cl. G06Q 50/00; G06Q 20/22; H04L 12/58; G06Q 30/00; G06F 17/27; G06F 17/30; G06Q 30/02; G06Q 10/06; H04L 29/06

(52) U.S. Cl. CPC G06Q 50/01; G06Q 10/063112; G06Q 20/29; H04L 51/10; H04L 51/046; H04L 67/42; G06F 17/277; G06F 17/30377; G06F 17/3053; G06F 17/30528; G06Q 30/0282; G06Q 30/0185; G06Q 30/0208

(57) ABSTRACT

The present invention relates generally to the field of providing a computer-implemented system and method that provides a micro-transaction based, crowd-sourced expert system marketplace in which answers from human experts are provided within a guaranteed period of time to electronically submitted questions by human users. The invention is a computer-implemented system and method that provides a micro-transaction based marketplace in which electronically submitted questions in text or picture form from human users are parsed, categorized and routed in real-time and then transmitted electronically to the best available human experts with a response guaranteed within a specified time.

### CROSS-REFERENCE TO RELATED APPLICATIONS

This application claims the benefit of U.S. Provisional Application No. 62/081,030, filed on Nov. 18, 2014, the content of which is incorporated herein by reference.

### FIELD OF THE INVENTION

The present invention relates generally to the field of providing a computer-implemented system and method that provides a micro-transaction based, crowd-sourced expert system marketplace in which answers from human experts are provided within a guaranteed period of time to electronically submitted questions by human users. The invention is a computer-implemented system and method that provides a micro-transaction based marketplace in which electronically submitted questions in text or picture form from human users are parsed, categorized and routed in real-time and then transmitted electronically to the best available human experts with a response guaranteed within a specified time.

### BACKGROUND

The problem the present invention addresses is fully automating in a computer-implemented system, the process by which electronically submitted questions by human users are submitted, parsed, categorized and then routed to the best available human experts to answer the question in a guaranteed period of time. The present invention also addresses the computer-implemented processes by which experts are ranked in their areas of expertise. And finally the present invention addresses the computer-implemented processes by which micro-transaction based currency exchange provides the necessary economic incentive for subject matter experts to participate.

The present invention focuses on helping human beings who are trying to learn something or study for something to get help from other human beings within a guaranteed time period. These potential users may need help in solving a specific problem, or for more general learning. If a person has a question on a subject or a problem, the ideal solution is one where they can get the best possible answer to their question, instantly, from the best expert in the field.

This ideal is very hard to accomplish given that finding the best expert is not easy in the first place, and even if they can be found, finding them in a timely fashion is very hard. The computer-implemented system of the present invention provides for finding an expert in a very short time, in fact a guaranteed amount of time, who will answer a question on any subject.

Current approaches that attempt to provide online answers to questions have many problems. There are three approaches that exist currently:

1. Web Search: Many people use web search engines like Google or Bing to submit a generic query such as “English Grammar Help” or a specific question like “Is divine a noun or an adjective?” The approach used to answer this question by search engines is well known. The engines have already crawled and indexed all websites containing relevant information, and those websites/links that are most relevant to the query submitted are returned as a search result. This approach has some possibility that a grammar expert may have created a website, but it also may not. Also, the specific question may not be answered for the user: but perusal of several links and some reading may yield the answer. In this case the answer is “Both. It's usually an adjective, as in the divine Lord, but sometimes its used as a noun, as in Lord, the Divine”. While search results are instant, the specific answer from an expert cannot be guaranteed.

2. Online Tutoring: Sometimes students use websites to find tutors who are “experts” in a subject. In this case it is possible to go to a website such as tutor.com, and ask for a tutor in English, and set up an appointment for a web videoconferencing session, and ask one or more questions during the session. In this approach, it is relatively certain you are getting some sort of expertise, but it is not instantly available: appointments may take an hour or a day to obtain.

3. Online Q&A site: Sometime people post questions on Q&A sites like Yahoo answers, or Quora. In this case you don't know when you will get answers, and whether they are from experts at all.

In summary, the problem of getting expert answers to a wide variety of questions in a very short, guaranteed timeframe, via a computer-implemented system has not been solved.

### SUMMARY

The present invention relates generally to the field of providing a computer-implemented system and method that provides a micro-transaction based, crowd-sourced expert system in which answers from human experts are provided within a guaranteed period of time to electronically submitted questions by human users. The invention is a computer-implemented system and method that provides a micro-transaction based marketplace in which electronically submitted questions in text or picture form from human users are parsed, categorized and routed in real-time to the best available experts and a response is guaranteed within a specified time.

The approach of the present invention is to create a digital marketplace of users and experts. Users can post questions on any topic and experts are instantly notified of questions that they may be interested in, and these experts have a monetary incentive to immediately answer the question if they can. Users are able to pay for answers, using micro-transactions. If for some reason, a human expert is not available, the system will use its knowledge base to return to the user a previous answer from a human expert to a similar question, within the guaranteed window of time.

In order for the marketplace to work, there has to be a minimal yet sufficient number of users and experts to create a steady volume of questions and answers so that the algorithms of the present invention can operate correctly. This is often known as the “bootstrap” problem. The present invention bootstraps the marketplace by creating a dedicated cadre of experts willing to answer questions in the N minute guaranteed Service Level Agreement (SLA) window simply by directly providing an economic incentive to these experts, even if the users are not yet willing to provide that economic incentive in the bootstrap phase.

Monetary incentives are provided in the form of a virtual currency called “credits” that users get free from the system in the bootstrap phase, and are transferred to experts when they provide acceptable answers to questions. During the bootstrap phase, experts are reimbursed by the system, for the credits they've collected, by setting a standardized exchange rate.

On the other side of the marketplace, the present invention uses marketing techniques to collect users. In one embodiment for example, users are high school students who need math help. The present invention advertises to users on social media channels such as Facebook. The prevention invention gathers from these social media channels a critical mass of users in the bootstrap phase. When they join the marketplace they are automatically given several thousand credits for free, to spend on asking questions. This creates a free flow of questions and answers between users and experts until a sufficient scale is reached for the algorithms described below to start working. After the bootstrap phase, users do not get credits for free. Credits must be paid for after the bootstrap phase. Payment methods include but are not limited to in-app purchases or credit cards in the mobile app of the present invention.

Each expert in the system has a set of topics/subjects that they will offer answers for. Experts are ranked against each topic/subject in their profiles. The ranking score of an expert for each subject is calculated based on a number of factors including but not limited to:
Average Claim Time: C seconds
Average Response Time: R seconds
Percentage of claims/available questions: PC
Percentage of answers meeting SLA: PSLA
Percentage of answers having high rating (Yes): PR
Volume of answers

ExpertScore=w1×(Cmax−C)/Cmax+

w2×(Rmax−R)/Rmax+

w3×PC+

w4×PSLA+

w5×PR
Cₘₐₓ is the maximum time an expert is allowed to claim the question. In one embodiment of the present invention 30 seconds is used as the maximum number, which may require three rounds of routing to have a question claimed by an expert.
Rₘₐₓ is the maximum time an experts is allowed to answer a question from the time s/he claims the question. In one embodiment of the present invention 10 seconds is used.
w₁, w₂, w₃, w₄, w₅ are weighting parameters
   For example, if an expert has the average claim time of 7 seconds, average response time of 531 seconds, % of claims/available questions of 89%, % of answers meeting SLA of 90%, % of answers have yes votes of 17% then the ExpertScore is: 2.84

If two experts have the same ExpertScore, the expert who has a better volume of answers will be ranked higher when comparing two experts. If two experts have the same ExpertScore and Volume then one of them is picked randomly.

In the one embodiment of the present invention questions can come in multiple forms including but not limited to: in one embodiment, text or in another embodiment a photo of a page in a textbook with the question highlighted.

Example 1: “How do you prove the Pythagorean Theorem?” is a text question.
Example 2: Photo from a high school math textbook with the highlighted question

Regardless of the form of the question submitted, in one embodiment of the present invention both automated and human techniques are used categorize the questions.

In the human form, one technique is to ask the user to tag the question as a geometry or algebra or trigonometry question. If the user tags it incorrectly, an expert may change the tag to correct it.

Another way to categorize the questions is through interpretation, which uses automated techniques described below. To “interpret” a question suggests some degree of understanding the system has of the “meaning” of the question.

Example: “Do you use the word “sleeped” or “slept” for the past tense of sleep?” requires an algorithm than can deduce the meaning of the question. In one embodiment of the present invention natural language parsing techniques and analysis are used to classify the question into a metadata structure and assign it meaning, beyond what user-submitted categorization would offer.

So in the example “Do you use the word ‘sleeped’ or ‘slept’ for the past tense of sleep?” the categorization of the question provided by the user may have specified “English Grammar” but the automated technique may add the interpretation “tense related question”. These techniques work for text questions, but may not work for photo questions. Hence interpretation is an additional possible parameter, beyond categorization that is used by the system of the present invention.

Once the system has both a human categorization and an automated interpretation it is ready to route the question to the best expert.

In one embodiment of the present invention the system uses a combination of ExpertScore (described above), Question Categorization, Question Interpretation, and Expert Self Classification to determine the best expert/s to send the question to. The algorithm creates an ordered list of experts ranked 1 to N: effectively providing an estimate of the best candidates for answering the question.

The list is further divided into levels. All experts in the list are segmented into different levels for each subject/topic in their profiles. Experts at higher levels have higher priority in getting new questions. All experts start with Expert-Level 0, then the level will be increased by 1 whenever they achieve a block of 100 answers in which 90 or more answers meet the SLA and have “Yes” votes (i.e. qualified answers) from users. If the number of qualified answers in the next block is less than 70, their Expert-Level will be decreased by 1.

In one embodiment of the present invention, the routing algorithm works as follows. An expert is considered active if he/she is active on the platform in the last 7 days and is not busy answering other questions at the current time. Whenever a new question is posted, its tag will be used to locate the best possible experts. Starting at the highest expert level for that tag, the routing system finds, as one example, 5 experts with the highest ranking and routes the question to all of them in parallel. Any of those experts are able to claim the question, on a first come first serve basis. Once an expert claims the question, the expert has to give the answer within the N minute SLA guarantee window

If no one claims the question within X seconds, the system will find another, for example, 15 experts in the same level or lower depending on the availability at that level and give them 20 seconds to claim. If still no one claims the question, system will find next 30 experts and give them 10 seconds to claim. The platform needs to have enough experts to ensure that at least one claim for each question after three rounds of routing.

When an answer is posted, the system will prompt the user who asked question to rate the answer, if the answer is accepted then the expert will get credits for the answer. If not, the user will have an option to repost the question for free to find other experts.

If an expert claims a question but is not able to give an answer within 10 minutes, the question will be marked as new and available for others to claim. In that case, the question is considered as unqualified question for that expert in the level calculation.

Each time an answer is marked acceptable by a user, both the question, with its answer is added to the knowledge base, along with the categorization and interpretation, and who asked it, and who answered it.

Some questions, which come as photos, are not easy to parse and require a photo to be further broken down into a text phrase or question for the system parser to work. The system uses a human assisted photo interpretation approach to accomplish this. The system uses the incentive of credits, to have any user who wants to earn some extra credits translate a photo question to a text question. The incentive for users is so they can ask future questions for free with these credits. The incentive for experts is so they can cash these credits in for money. Once the categorization for the submitted photo question is done it can be added to the knowledge base with its interpretation.

The system is designed to meet the SLA guarantee, regardless of whether an expert is currently available. In one embodiment of the present invention, this is accomplished by using the knowledge base as the “safety net” to provide at least a relevant answer to the question, if not a precise answer to the question. If no expert is willing to claim the question and answer it within the SLA window, then a very short time before the window expires, the system chooses the most relevant similar question and answer from the knowledge base, based on categorization and interpretation. Note that the answer provided is NOT an automatically system-generated answer: it is a human expert answer to a similar question in the past. Thus the user is always getting a human expert answer.

Because this is an answer that does not cost anything, the system provides this answer for significantly less credits than a real time expert answer, and in some instances may even be provided free.

All the existing alternatives described for providing immediate expert answers to questions have problems. Thus, there is a need for a computer-implemented system and method that automates the process such that an online user can get an answer to their question from a human expert in a guaranteed period of time.

Therefore the approach of the present invention is designed to automate the process of providing expert human answers to online submitted questions by providing:

1. Economic Incentive

2. Expert Ranking

3. Guaranteed Response Time

### BRIEF DESCRIPTION OF THE DRAWINGS

FIG. 1 is an overview block diagram of the major components and users of a computer-implement client-server system that provides answers from human experts within a guaranteed period of time to electronically submitted questions from human users according to one embodiment of the present invention;

FIG. 2 is a state machine diagram of a computer-implemented question-routing-state-machine according to one embodiment of the present invention;

FIG. 3 is a state machine diagram of a computer-implemented expert-state-machine according to one embodiment of the present invention

### DETAILED DESCRIPTION

Embodiments of the present invention provide a computer-implemented system and method that provides a micro-transaction based, crowd-sourced expert system in which answers from human experts are provided within a guaranteed period of time to electronically submitted questions by human users. The invention is a computer-implemented system and method that provides a micro-transaction based marketplace in which electronically submitted questions in text or picture form from human users are parsed, categorized and routed in real-time to the best available experts and a response is guaranteed within a specified time.

In one embodiment of the present invention the computer-implemented system is a client-server system. The users of the systems include but are not limited to those users of the system that submit questions to be answered and those users of the system that provide expert answers. The users of the system may use a wide variety of client devices or interfaces to access the server system of the present invention, including but not limited to web browsers, mobile apps and other client devices or interfaces.

As an overview of the present invention, the following description shows an example of how the marketplace of users and experts is bootstrapped and then shows the flow of question submittal, question parsing, question routing, expert selection, and expert answer response in one embodiment of the present invention using the system and method of the present invention.

In one embodiment of the present invention, the initial marketplace of users and experts is bootstrapped and established through the following steps:

1. Virtual credits are provided free to potential users and are transferred to experts when they provide acceptable answers to submitted questions.

2. During the bootstrap period, virtual credits earned by the experts are reimbursed by the system at a standardized exchange rate.

3. Marketing techniques are used to collect users. For example, in one embodiment of the present invention, high school students who need math help are targeted on social media such as Facebook.

4. Users who join during the initial bootstrap period are given several thousand credits for free to spend on asking questions.

5. During the bootstrap phase, this process creates a free flow of questions and answers until a sufficient scale is established for the paid phase of the marketplace to begin.

6. After the bootstrap phase, users do not get credits for free. They must be paid for. In one embodiment of the present invention this is accomplished with in-app purchases in the mobile app.

In one embodiment of the present invention, an overview of the flow of question submittal and question routing processing includes but is not limited to the following steps:

1. Using either a web browser or a mobile app of the present invention the user submits a question.

2. Submitted question is parsed and classified.

3. Question is routed to the currently available set of experts with the highest ranking, for the type of question submitted.

4. The first expert to claim the question has a fixed time limit to respond.

5. Expert responds and the answer is persisted in knowledge base

6. Expert answer is returned to user.

7. User provides a rating of the returned expert answer.

8. Expert's ranking is computed based on user rating and response time.

9. Fraud and test cheating is monitored for within the questions submitted.

10. User is charged a micro-transaction fee for every accepted answer with the SLA time period.

11. Expert is credited a micro-transaction fee for every accepted answer given with the SLA time period.

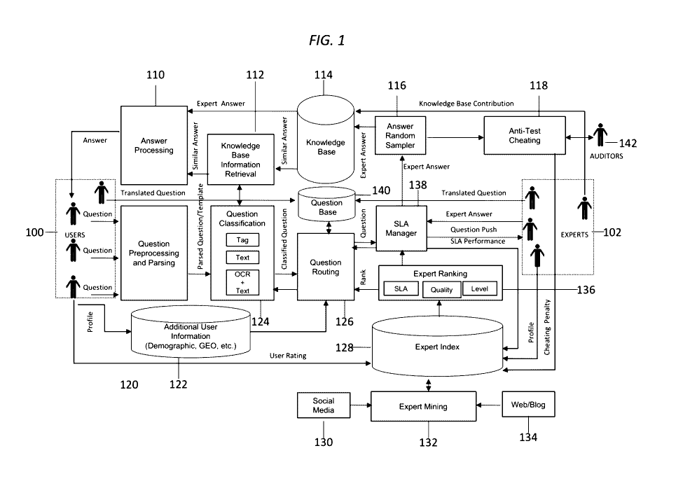

FIG. 1 is an overview block diagram of a computer-implement client-server system, according to one embodiment of the present invention, which provides answers from human experts within a guaranteed period of time to electronically submitted questions from human users.

Referring to FIG. 1 this figure provides an overview of the server components and human users of a computer-implement client-server system according to one embodiment of the present invention. Referring to FIG. 1 those elements depicted with a human icon represent various users of the system that access the system via various client interfaces or devices including but not limited to web browsers and mobile apps. Referring to FIG. 1 all the other elements depicted in the figure are the computer-implemented components of the server-side system of a client-server system according to one embodiment of the present invention.

Referring to FIG. 1, in one embodiment of the present invention, human users 100 submit questions electronically to be answered in a specified period of time by human experts 102. In one embodiment of the invention the questions submitted by human users 100 are submitted electronically via a web or mobile app interface. In one embodiment of the present invention questions can be submitted as text or as an image (e.g. a photo of a math problem from a high school textbook). The ability for the human user 100 to submit questions as photos greatly simplifies the usability of the invention. Many scientific or math questions are difficult to enter on web or mobile devices. Allowing the human user 100 to take a photo of the question from a textbook or other source greatly simplifies ease of use. In addition to submitting a question in either text or image form the human user 100 also has the ability to self-categorize the question (e.g. high school calculus question, algebra question, geometry question etc.)

Still referring to FIG. 1, submitted questions are first processed by the question preprocessing and parsing component 120 of the server system according to one embodiment of the present invention. This component parses and pre-processes the submitted question in text or image form along with the user's categorization to produce a canonical form of the question. The output of this parsing process is passed to question classification component 124, which adds question classification information. The meta-structure a classified question can take includes several elements depended upon the form in which the question was submitted. The possible meta-structures for classified questions include but are not limited to [TAG]+[TEXT], [TAG]+[PHOTO], [TAG]+[PHOTO]+[TEXT], [TAG]+[TEXT]+[OCR] etc. In all cases [TAG] represents a system coding of the type of question based either on human user input or system analysis of the submitted question.

Still referring to FIG. 1, the classified question is then passed to the question routing component 126 of the server system. The question routing component 126 uses several inputs for determining which expert to route the question to. One input is of course the question meta-structure created by the question clarification component 124. Another input is the user profile obtained from the user profile database 122. The user profile 122 can aid in the routing decision because it gives additional information about the user 100. For example, if the user is a high school student this can help determine which experts 102 are best suited to answer a high school students question. The other important input to the routing algorithm is the information contained in the expert index database 128.

The question routing component 126 of the server system persists the question meta-structure and its current state into the question base database 140. The question base database 140 keeps the canonical meta-structure for all active questions. The question meta-structure includes a “state” element reflecting the current state of the question. Values for the “state” of an active question include but are not limited to values such as, queued, routed, potentially claimed, answering, initial answered, flagged, skipped, pending, claimed but not answered, timeout, micro-session, micro-session completed, micro-session incomplete, limbo, KB waiting, KB answered, Ops answered, rated, dead etc.

Based on the category of the question, the question routing component 126 gets a list of the highest ranked free experts from the expert ranking component 136. The expert ranking component 136 accesses the expert index database 128 for the past rankings of experts. The expert index database 128 holds a profile for each human expert as well their ranking and any anti-test-cheating penalties applied to their ranking

Still referring to FIG. 1 in one embodiment of the present invention, once the question routing component 126 has obtained a list of available high ranking experts for a question category, the question and the list of available experts 102 is passed to the SLA manager component 138, for distribution to the list of selected experts for claiming the question. Before answering a question, an expert 102 first must claim a question and then has a period of time in which to provide an answer or indicate they cannot answer the question, in which case it can be claimed by another of the available high ranking experts 102 from the list.

The SLA manager 138 component distributes the question to the first available expert 102 from the list that claims the question. The SLA manager component 138 monitors their response.

The SLA manager component 138 in one embodiment of the present invention monitors the quality and timeliness of responses provided by experts 102. The SLA manager component 138 passes this quality and timeliness information to the expert index 128. The expert ranking component 136 uses all the information in the expert index 128 to rank the experts 102. The expert ranking component 136 ranks the experts 102 by using criteria including but not limited to claim time in seconds, response time in seconds, percentage of claims made for available questions, percentage of answers meeting SLA, percentage of answers having high ratings, volume of answers, etc.

Still referring to FIG. 1 in one embodiment of the present invention, the ranking of experts 102 is done by the expert ranking component 136. In one embodiment of the present invention the algorithm for computing the expert score is the following:

ExpertScore=w1×(Cmax−C)/Cmax+

w2×(Rmax−R)/Rmax+

w3×PC+

w4×PSLA+

w5×PR

Where in one embodiment of the present invention

Cmax is the maximum time an expert is allowed to claim a question (default=30 secs)

Rmax is the maximum time an expert is allowed to answer a question from the time it is Claimed (e.g. default=10 mins)

w1,w2,w3,w4, and w5 are weighting parameters.

For example, in one embodiment of the present invention, if an expert has an average claim time of 7 seconds, an average response time of 531 seconds, % of claims/available questions of 89%, % of answers meeting SLA of 90%, % of answers have yes votes of 17% then the expert score is 2.84. If two experts 102 have the same expert score, then the expert 102 who has the higher volume will be ranked higher.

Still referring to FIG. 1 of the present invention, when an expert 102 returns an expert's answer to an outstanding question to the SLA manager component 136 it is passed to the answer random sampler component 116, which then puts the answer into knowledge base database 114. Asynchronously the answer random sampler component 116 pushes a random sample of questions and answers to the anti-test-cheating component 118. Periodically human auditors 142 access the anti-test-cheating component 118 to examine a random sample of questions and answers. The human auditor 142 is looking for examples of questions and answers that involve cheating on tests. An example of this might be a multiple-choice question from a test. If this sort of question and answer combination is detected, then the human auditor 142 assesses a penalty to the expert who answered it and that penalty is applied to the expert index database 128.

Still referring to FIG. 1 of the present invention, after an expert answer to an outstanding question is persisted in the knowledge base database 114, the expert answer is passed to the answer-processing component 110, which pushes the expert answer to the user 100. After examining the answer, the user 100 provides a user rating of the expert's answer, which is persisted, in the expert index database 128.

Still referring to FIG. 1 of the present invention, if no expert 102 is available to answer a question, the question classification component 124 passes the question to the knowledge base information retrieval component 112. The knowledge base information retrieval component 112 accesses the knowledge base database 114 attempting to find a similar question and its answer. If a similar question with an expert answer is found in the knowledge base database 114, the knowledge base information retrieval component 112 passes the similar expert answer to the answer processing component 110, which in turn pushes the similar expert answer to the user 100.

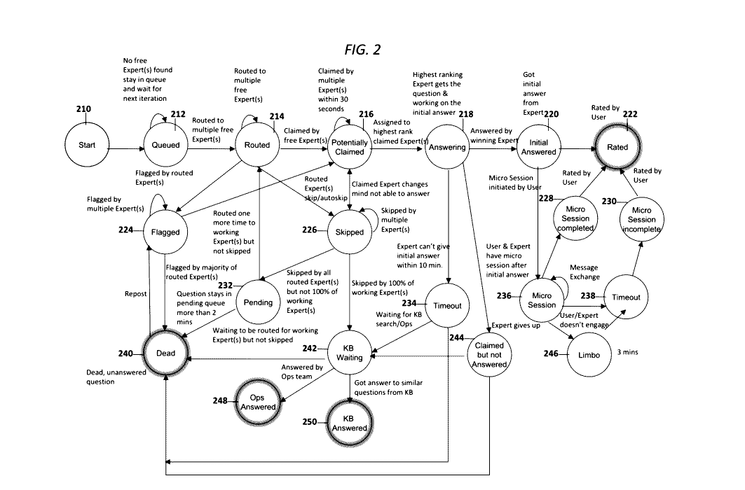

Still referring to FIG. 1 of the present invention, the knowledge base database 114 and the knowledge base information retrieval component 112 also allows for the testing and pre-rating of new experts 102. Users 100 are provided economic incentive to submit pre-existing questions from the knowledge base database 114, using the knowledge base information retrieval component 112 to access both the questions and the previously recorded answers. When the experts 102 respond to the previously answered questions, the users 100 can use the previously recorded answer for the same question accessed from the knowledge base database 114 to rate the answer of the expert 102. Using this method, a new expert 102 can be provided an initial rating which will allow them to compete fairly for subsequent questions submitted from users 100.

Where as FIG. 1 is a component view of the system according to one embodiment of the present invention, FIG. 2 by contrast is a state machine diagram of the question state machine according to one embodiment of the present invention.

Referring to FIG. 2, in one embodiment of the present invention, submitted questions by human users are represented as a data structure in the system. In one embodiment of the present invention a question data structure is passed through the system by reference. The description of the of the variants of the question data structure is described above for FIG. 1 according to one embodiment of the present invention. A question data structure is permanently persisted in the question base database 140 depicted above for FIG. 1. A question data structure goes through many state changes as it is passed through the system from human user to human expert and as it is acted upon by the different components of the system. FIG. 2 depicts the state changes a question data structure goes through according to one embodiment of the present invention.

Still referring to FIG. 2 of the present invention, according to one embodiment of the present invention, a question's initial state is the start state 210 after it is submitted by a user. If no free experts are found to route the question to, the question state is changed to the queued state 212 waiting for the next iteration of routing. When a question has been routed to a set of free experts the question's state is changed to the routed state 214. When a question has been claimed by a free expert or a set of free experts its state is changed to the potentially claimed state 216.

Still referring to FIG. 2 of the present invention, when a question has been claimed by a free expert or a set of free experts, it is then assigned to the highest-ranking expert and the question's state is changed to the answering state 218. When the selected expert answers the question its state is changed to the initial answered state 220 and the answer is returned to the user. When the user rates the quality of the answered question the state of the question is changed to the rated state 222. The rated state 222 is one of the endpoint states for a question.

Still referring to FIG. 2 of the present invention, according to one embodiment of the invention, when a question is in the initial-answered state 220, a micro-session can be initiated by the user. A micro-session is a direct question and answer chat session between the user and the expert in order to allow the user to ask clarifying questions or ask for more details.

If a user initiates a micro-session the state of the question is changed to the micro-session state 236. While in the micro-session state messages can be exchanged between the user and the expert. When the micro-session completes successfully the state of the question is changed to the micro-session completed state 228. From here after the user rates the answers to their questions, the state of the question is changed to the rated state 222, which is an endpoint state.

However, if either the user or expert does not engage in the micro-session the state of the question is changed to the timeout state 238. From there the state of the question is changed to the micro-session incomplete state 230. From there when the user provides a rating to the answer(s) from the expert the state of the question is changed to the rated state 222 which is an endpoint state.

If the user and expert do engage in the micro-session but there is a problem in communications between the two, the state of the question is changed to the limbo state 240. From there after a period of 3 minutes the system will change the state of the question to the timeout state 238. From there the state of the question will follow the state descriptions changes previously described above.

Still referring to FIG. 2 of the present invention, according to one embodiment of the invention, there are additional states a question can take beyond the nominal flow described above. If after a question is in the routed state 214, if it is flagged as an invalid question by one or more free experts the question's state is changed to the flagged state 224. If the majority of routed experts flag the question as invalid, the state of the question is changed to the dead state 240. The dead state 240 is an endpoint state in the system.

Still referring to FIG. 2 of the present invention, according to one embodiment of the present invention, after a question has been routed to a set of free experts one or more can choose to skip a question. The subset state of a question for that expert is changed to the skipped state 226. If a question is skipped by 100% of the working experts the state of the question is changed to KB waiting state 242. The system will first attempt to answer a question in the KB waiting state 24 by consulting the knowledge base database (114 of FIG. 1 above) to find a similar previously submitted question with its corresponding answer. If such a question and its corresponding answer is found the answer is returned to the user and the state of the question is changed to the KB answered state 250. The KB answered 250 is an endpoint state.

If a similar question cannot be found in the knowledge base database (114 of FIG. 1 above), the operations state will attempt to answer the question. If the ops staff can answer the question, the answer is returned to the user and the state of the question is changed to the ops answered state 248. The ops answered state 248 is an endpoint state. If the system cannot find an answer using either the knowledge base database (114 of FIG. 1 above) or the ops staff, then the state of the question is changed to the dead state 240. The dead state 240 is an endpoint state.

Still referring to FIG. 2 of the present invention, according to one embodiment of the invention, after a question is in the answering state 218 if the expert does not give an answer within the timeout period, the state of the question transitions to the timeout state 234. From here the state of the question transitions to the KB waiting state 242 and follows previously described state transitions.

Still referring to FIG. 2 of the present invention, according to one embodiment of the invention, after a question is in the answering state 218, if the expert overtly gives up on the question, the state of the question is changed to the claimed but not answered state 244. From there the state of the question is changed to the dead state 240, which is an endpoint state.

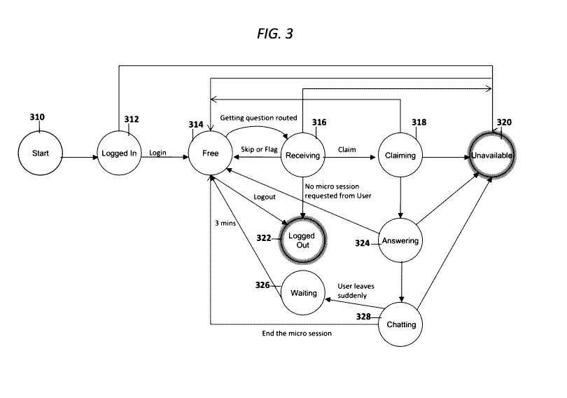

FIG. 3 is a state machine diagram of the expert-state-machine according to one embodiment of the present invention.

Referring to FIG. 3, in one embodiment of the present invention, the state of human experts is represented as by a data structure in the system. The state of any experts not logged-in is the start state 310. When an expert logs in the state changes to the logged-in state 312. From the logged-in state 312 it immediately transitions to the free state 314.

When a question is routed to an expert the state is changed to the receiving state 316. If a expert in the receiving state 316, skips or flags a question the state of the expert reverts to the free state 314. If an expert in the receiving state 316, claims a question then the state is changed to the claiming state 318. If from the claiming state 318, the expert becomes unavailable the state is changed to the unavailable state 320, which is an endpoint state.

However, if an expert in the claiming state 318 begins answering the question the state is changed to the answering state 324. From the answering state 324 the expert can become unavailable which causes the state to change to the unavailable state 320, which is an endpoint state.

From the answering state 324 the expert upon answering the question transitions to the free state 314. From the answering state 324 the user can request a micro-session in which case the state of the expert transitions to the chatting state 328. If the user leaves a micro-session the state of the expert transitions to the waiting state 326 and then after a timeout period back to the free state 314. Alternatively, when the micro-session is complete the expert transitions back to the free state 314. At any time in the free state 314, the expert can log out which transitions their state first to the logged-out state 322.

1. A computer-implemented system and method consisting of a client-server system which includes but is not limited to a plurality of client devices and a server which is coupled to the plurality of client devices over a data communications network; said client-server system provides a micro-transaction based marketplace in which electronically submitted questions in text or picture form from human users are submitted via a plurality of client devices over a data communications network to a server; submitted questions received at the server are parsed, categorized and routed in real-time over a data communications network to the client devices of the best available human experts and a response is guaranteed to the users within a specified time, the system and method of the server comprising:
a processor; and
a memory coupled to the processor and storing program instructions therein, the processor being configured to execute the program instructions, the program instructions comprising:
accepting electronically submitted questions from human users in text or picture form;
parsing questions into a canonical form;
classifying questions based on fields of expertise;
selecting a set of the highest ranking currently available experts based on question classification;
routing the question to the selected set of highest ranking currently available experts;
recording which expert first claims the question;
monitoring the claiming expert's response time to the claimed question;
persisting the claiming expert's answer to the question to a knowledge database;
returning the expert's answer to the human user who submitted the question;
recording the human user's rating of the quality of the expert's answer;
computing the expert's ranking based on response time and quality of the answer;
monitoring questions to detect fraud or test cheating attempts;
charging the user, a micro-transaction fee for every accepted answer received within the SLA time period;
crediting the expert, a micro-transaction payment for every accepted answer received with the SLA time period;
rating experts based on user ratings of answers and SLA performance;

2. The method of claim 1, wherein the expert's ranking is a weighted average calculation of factors including but not limited to average response time, average claim time, percentage of claims/available questions, percentage of answers meeting SLA, percentage of answers having high rating, and volume of answers.

3. The method of claim 1, where in a new expert can be provided an initial rating by providing economic incentive to users to submit previously recorded questions to new experts stored in the knowledge base database and to rate the answers from the new expert based on the previously recorded answer to the same question recorded in the knowledge base database.
